(19) United States
(12) Patent Application Publication
(10) Pub. No.: US 2026/0253056 A1
(43) Pub. Date: Aug. 27, 2026

(54) OFFLINE NFT PHOTO CARD TRANSACTION METHOD AND APPARATUS

(71) Applicant: WEVERSE COMPANY INC., Seongnam-si (KR)

(72) Inventor: Dong Hyun KIM, Seongnam-si (KR)

(21) Appl. No.: 19/649,597

(22) Filed: Apr. 16, 2026

Related U.S. Application Data
(63) Continuation of application No. PCT/KR2024/015593, filed on Oct. 15, 2024.

(30) Foreign Application Priority Data
Oct. 17, 2023 (KR) 10-2023-0138280
May 9, 2024 (KR) 10-2024-0061320

(51) Int. Cl. G06Q 20/34

(52) U.S. Cl. CPC G06Q 20/341

(57) ABSTRACT

An embodiment of the present disclosure relates to an offline NFT photo card transaction method and apparatus, capable of providing an offline NFT photo card transaction at locations where fans are concentrated, such as a pop-up store and a concert hall.

### CROSS-REFERENCE TO RELATED APPLICATIONS

This application is a Continuation of Application No. PCT/KR2024/015593, filed on October 15, 2024, which in turn claims the benefit of Korean Patent Applications No. 10-2023-0138280, filed on October 17, 2023, and No. 10-2024-0061320, filed on May 09, 2024. The entire disclosures of all these applications are hereby incorporated by reference.

### TECHNICAL FIELD

[1] The present disclosure relates to an offline NFT photo card transaction method and apparatus, and more particularly, to an offline NFT photo card transaction method and apparatus that enables NFT photo cards to be traded offline at locations where fans of an artist gather, such as a pop-up store or a concert hall.

### BACKGROUND ART

[2] With the growth of the entertainment industry, the market for photo card-related products and services has expanded. A photo card refers to card-type merchandise bearing a photograph of a well-known person, such as a celebrity. Photo cards are available in various formats, and, more recently, photo cards incorporating non-fungible tokens (NFTs) have emerged as a new market segment.

[3] Photo cards reflect a combination of Western trading card culture and Korean K-pop culture and are also exported overseas. In K-POP, the marketing strategies are used to increase album sales by creating multiple photo cards for each group member and randomly including only one or two such cards.

[4] Photo cards may be broadly categorized into album photo cards, unreleased photo cards, public-broadcast photo cards, and unofficial photo cards. The album photo cards are photo cards included as part of an artist’s album package. Unreleased photo cards are official photo cards provided as a special gift through album retailers. Examples of unreleased photo cards include 'special pre-sale photo cards' provided upon purchase of an album during a pre-sale period, 'special fan-sign event application photo cards' provided upon purchase of an album during a fan-sign event application period, and 'lucky draw photo cards' selected through a lucky draw upon purchase of an album.

[5] Public-broadcast photo cards are distributed when fans attend public broadcasts, usually music broadcasts. Unlike the album photo cards and unreleased photo cards, public-broadcast photo cards may not be provided at every venue. Unofficial photo cards are produced unofficially by small printing companies or fans to take advantage of the popularity of photo cards.

[6] Accordingly, the K-POP industry employs marketing strategies that randomly distribute photo cards to increase album sales. For this reason, fans often purchase multiple albums or divide albums among themselves to collect all types of photo cards. In addition, fans actively trade photo cards to collect all album photo cards of a specific member or to post photos of complete member-specific collections from a particular album.

[7] Photo card trading continues to be very active because photo cards share similarities with Western trading card culture. In particular, some people seek only wish-list photo cards, i.e., highly sought-after photo cards, while others seek photo cards from all albums or all members.

[8] However, as photo card trading becomes more active, the price of photo cards may rise sharply or drop sharply depending on the popularity of the celebrity and the rarity of the photo card. Accordingly, fans who trade photo cards may have difficulty accurately determining the current market price of a photo card.

[9] In addition, as the price of photo cards rises and trading becomes more active, fraudulent activities such as trading scanned or duplicated copies instead of genuine photo cards have occurred, thereby reducing fan trust in the products. Fans may also have difficulty locating counterparties for photo card transactions because they must search for such counterparties directly.

### DISCLOSURE

### TECHNICAL PROBLEM

An objective of an embodiment of the present disclosure is to enable NFT photo card transactions by setting an area for NFT photo card transactions.

Another objective of an embodiment of the present disclosure is to facilitate the search for a transaction counterparty for an NFT photo card transaction.

Another objective of an embodiment of the present disclosure is to improve the safety of NFT photo card transactions.

However, the technical objectives of the present embodiment are not limited to those as described above, and other technical tasks may exist.

### TECHNICAL SOLUTION

An offline NFT photo card transaction method according to an embodiment of the present disclosure includes: setting an offline NFT photo card transaction area; registering an NFT photo card to be traded by an NFT photo card holder; matching an NFT photo card transaction counterparty for a user terminal located in the offline NFT photo card transaction area; setting a transaction place based on location information of the user terminal and a counterparty terminal when the NFT photo card transaction counterparty is matched; and performing an NFT photo card transaction when the user terminal and the counterparty terminal enter the transaction place.

In addition, an offline NFT photo card transaction apparatus according to an embodiment of the present disclosure includes: a communication module configured to transmit and receive information between a terminal and an offline NFT photo card transaction management server; a memory for storing at least one instruction; and a processor for executing the at least one instruction, wherein the processor is configured to: set an offline NFT photo card transaction area; register an NFT photo card to be traded by an NFT photo card holder; match an NFT photo card transaction counterparty for a user terminal located in the offline NFT photo card transaction area; set a transaction place based on location information of the user terminal and a counterparty terminal when the NFT photo card transaction counterparty is matched; and perform an NFT photo card transaction when the user terminal and the counterparty terminal enter the transaction place.

### ADVANTAGEOUS EFFECTS

An offline NFT photo card transaction method and apparatus according to an embodiment of the present disclosure can perform NFT photo card transactions by setting an area for NFT photo card transactions.

In addition, the offline NFT photo card transaction method and apparatus according to an embodiment of the present disclosure can facilitate the search for an NFT photo card transaction target.

In addition, the offline NFT photo card transaction method and apparatus according to an embodiment of the present disclosure can increase the safety of NFT photo card transactions.

### DESCRIPTION OF DRAWINGS

FIG. 1 is a conceptual diagram illustrating an offline NFT photo card transaction method according to an embodiment of the present disclosure.

FIG. 2 is an exemplary diagram illustrating a communication connection of an offline NFT photo card transaction apparatus according to an embodiment of the present disclosure.

FIG. 3 is a configuration diagram illustrating an offline NFT photo card transaction management server according to an embodiment of the present disclosure.

FIG. 4 is a conceptual diagram illustrating the functions of an offline NFT photo card transaction management server according to an embodiment of the present disclosure.

FIG. 5 is a configuration diagram illustrating a terminal according to an embodiment of the present disclosure.

FIG. 6 is a flowchart of an offline NFT photo card transaction method according to an embodiment of the present disclosure.

### BEST MODE FOR CARRYING OUT THE INVENTION

Hereinafter, embodiments and examples of the present disclosure will be described in detail with reference to the accompanying drawings so that the present disclosure may be readily implemented by those skilled in the art. However, it is to be noted that the present disclosure is not limited to the embodiments and examples but can be embodied in various other ways. In drawings, parts irrelevant to the description are omitted for the simplicity of explanation, and like reference numerals denote like parts throughout the entire specification.

Throughout the specification, when an element is referred to as being “connected” to another element, the element is “directly connected” to the other element, or “electrically connected” to the other element with another intervening element interposed therebetween. In addition, it will be further understood that when an element “comprises” or “includes” a component, the element may further “comprise” or “include” another component, and the presence of such components is not precluded, unless otherwise specifically stated.

In addition, the attached drawings are merely intended to facilitate easy understanding of the embodiments disclosed herein, and the technical ideas disclosed herein are not limited by the attached drawings. It should be understood that all modifications, equivalents and substitutes included in the spirit and technical scope of the present disclosure are included.

Terms that include ordinal numbers, such as “first” and “second,” may be used to describe various components, but the components are not restricted by the terms. The terms are used only to distinguish one component from another component.

It will be understood that when a component is referred to as being “connected” or “coupled” to another component, the two components may be directly connected or coupled to each other, or intervening components may be present between the two components. It will be understood that when a component is referred to as being “directly connected or coupled”, no intervening components are present between the two components.

A singular includes a plural expression, unless the context clearly states otherwise.

In the present specification, it will be understood that the terms “comprising” or “having,” when used herein, specify the presence of stated features, integers, steps, operations, components, parts, or combinations thereof, but do not preclude the presence or addition of one or more other features, integers, steps, operations, components, parts, or combinations thereof.

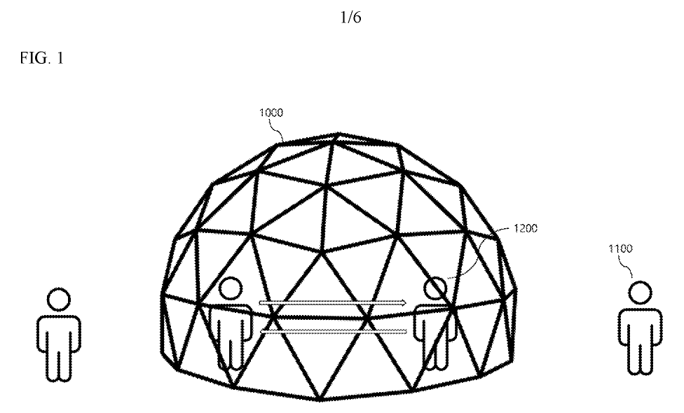

Hereinafter, an offline NFT photo card transaction method according to an embodiment of the present disclosure will be described with reference to FIG. 1.

FIG. 1 is a conceptual diagram illustrating an offline NFT photo card transaction method according to an embodiment of the present disclosure.

Referring to FIG. 1, the offline NFT photo card transaction method according to an embodiment of the present disclosure may set a specific space where a large number of fans gather, such as a pop-up store, a concert hall, or a fan meeting venue, as an offline NFT photo card transaction area 1000.

The offline NFT photo card transaction area 1000 may be set using a beacon installed at a designated base or booth. In addition, in the offline NFT photo card transaction area 1000, fans may trade or exchange their NFT photo cards using their own terminals.

Specifically, the offline NFT photo card transaction method may distinguish between a user 1100 located outside the offline NFT photo card transaction area 1000 and a user 1200 located within the offline NFT photo card transaction area 1000 based on the location information of the terminal.

In addition, the offline NFT photo card transaction method may match users 1200 located within the offline NFT photo card transaction area 1000 with transaction counterparties for NFT photo card transactions and exchanges.

Users matched with a transaction counterparty may set a location at which to conduct the transaction. When the users meet at the designated transaction place, the transaction or exchange of NFT photo cards may be performed.

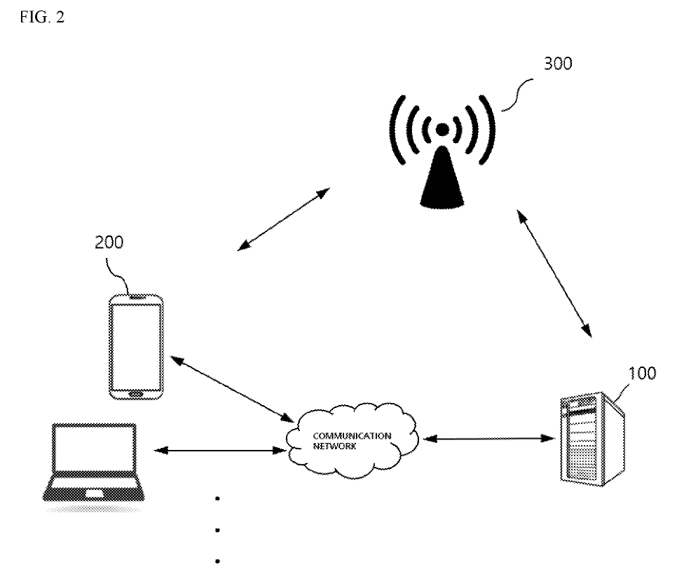

Hereinafter, the mutual operation between an offline NFT photo card transaction management server 100 and the terminal 200 according to an embodiment of the present disclosure will be described with reference to FIG. 2.

FIG. 2 is an exemplary diagram illustrating a communication connection between the offline NFT photo card transaction management server 100, the terminal 200, and a location information device 300 according to an embodiment of the present disclosure.

Referring to FIG. 2, the offline NFT photo card transaction management server 100, the terminal 200, and the location information device 300 are communicatively connected through a communication network. The offline NFT photo card transaction management server 100 may be a device that generates and manages NFT photo cards or stores information relating to NFT photo cards. For example, the server may be implemented as a fan platform server or a social networking service server that manages an application for transmitting and receiving fan content between a user or artist account and a fan account.

The offline NFT photo card transaction management server 100 may set the offline NFT photo card transaction area 1000 by communicating with the location information device 300 installed at a predefined venue, such as a pop-up store, a concert hall, a fan meeting venue, or a fan signing venue.

In addition, the offline NFT photo card transaction management server 100 may distinguish between terminals located within the offline NFT photo card transaction area 1000 and terminals located outside the offline NFT photo card transaction area 1000 based on the location information of the terminal 200 acquired using the location information device 300.

In addition, the offline NFT photo card transaction management server 100 may match a transaction counterparty for a terminal located within the offline NFT photo card transaction area 1000, set a transaction place, and perform data processing for the NFT photo card transaction.

In addition, the offline NFT photo card transaction management server 100 encrypts NFT photo card transaction data and stores the NFT photo card transaction data using blockchain technology, thereby preventing duplication of the NFT photo card and preserving the value of the NFT photo card.

The terminal 200 may be a terminal of a fan who holds an NFT photo card or trades an NFT photo card. Accordingly, the terminal 200 may be a terminal on which an application for offline NFT photo card transactions is installed or a terminal logged in using a fan account for trading NFT photo cards.

In addition, the terminal 200 may be a device that displays interface information, an NFT photo card list, NFT photo card information, NFT photo card transaction information, and NFT photo card transaction-related messages and notifications to a user from the offline NFT photo card transaction management server 100.

The terminal 200 may refer to all types of handheld-based wireless communication devices, such as a notebook on which a web browser is mounted, a desktop, a laptop, a wireless communication device in which portability and mobility are guaranteed, a smart phone, and a tablet PC.

The terminal 200 may acquire location information of the terminal 200 by performing a communication connection with the location information device 300 and transmit the acquired location information to the offline NFT photo card transaction management server 100.

In addition, the terminal 200 may receive data related to NFT photo card transactions, such as application interface information, NFT photo card transaction information, and transaction counterparty matching information, from the offline NFT photo card transaction management server 100, and display the received data using a display device of the terminal 200.

The location information device 300 may be a device for measuring location information of the terminal 200, such as a beacon device. The location information device 300 may use one or more beacon technologies, such as iBeacon, non-iBeacon, AltBeacon, URI Beacon (Uniform Resource Identifier Beacon), Placedge, Eddystone, sound-based low-frequency beacons, LED beacons, WiFi beacons, Bluetooth beacons, and BLE (Bluetooth Low Energy) beacons.

The location information device 300 may be installed at a predefined location or venue, and at least one location information device 300 may be installed together with a communication device used to control communications within a venue such as a pop-up store, concert hall, fan meeting venue, or fan-sign venue.

In addition, a plurality of location information devices 300 may be installed to define the offline NFT photo card transaction area 1000, and the offline NFT photo card transaction management server 100 may set the offline NFT photo card transaction area 1000 based on installation locations of the location information devices 300.

The location information device 300 periodically transmits its ID value and RSSI value as signals. Accordingly, when the terminal 200 enters a range in which a signal transmitted by the location information device 300 can be received, the terminal 200 may detect the signal and transmit corresponding information to the offline NFT photo card transaction management server 100.

The offline NFT photo card transaction management server 100 may determine the location of the terminal 200 using information received from the location information device 300, angle and distance information associated with the terminal 200, and AoA (Angle of Arrival) and AoD (Angle of Departure) techniques.

The communication network illustrated in FIG. 2 may be implemented as a wired network such as a LAN (Local Area Network), a WAN (Wide Area Network), or a VAN (Value Added Network), or all types of wireless networks such as a mobile radio communication network, a satellite communication network, Bluetooth, or NFC (Near Field Communication).

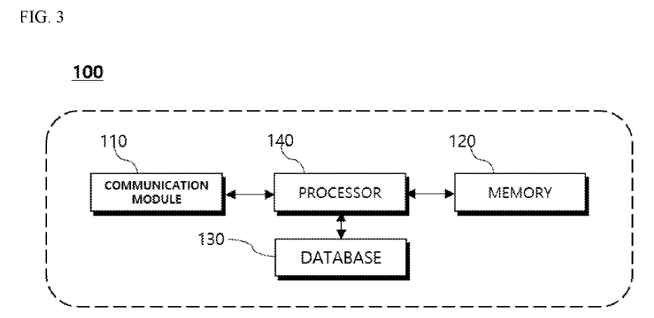

Hereinafter, the structure of the offline NFT photo card transaction management server according to an embodiment of the present disclosure will be described with reference to FIG. 3.

FIG. 3 is a structural diagram illustrating the structure of the offline NFT photo card transaction management server 100 according to an embodiment of the present disclosure.

Referring to FIG. 3, the offline NFT photo card transaction management server 100 may include a communication module 110, a memory 120, and a processor 140, and may further include a database 130. The communication module 110 communicates with the terminal 200 and may include hardware and software configured to transmit and receive signals, such as control signals or data signals, through wired or wireless connections with other network devices.

The memory 120 stores an offline NFT photo card transaction management program and/or instructions for performing offline NFT photo card transaction management. The term 'offline NFT photo card transaction management program' is used for convenience of explanation and does not limit the functionality of the program. The memory 120 may store at least one of the information and data input to the communication module 110, information and data necessary for functions performed by the processor 140, or data generated by the execution of the processor 140.

As used herein, the term 'memory' may include both a non-volatile storage device that retains stored information even when power is not supplied and a volatile storage device that uses power to retain stored information. In addition, the memory 120 may perform the function of temporarily or permanently storing data processed by the processor 140. The memory 120 may include magnetic storage media or flash storage media in addition to volatile storage devices that need power to maintain stored information, but the scope of an embodiment of the present disclosure is not limited thereto.

The database 130 may constitute a portion of the memory 120, but need not be located inside the offline NFT photo card transaction management server 100 and may be externally connected to the offline NFT photo card transaction management server 100 for data transmission and reception.

In addition, the database 130 may store NFT photo card data and NFT photo card transaction data using blockchain.

The processor 140 is configured to execute the offline NFT photo card transaction management program and/or instructions stored in the memory 120. The processor 140 may be embodied as a hardware-implemented data processing device having a physically structured circuit configured to perform a function represented by code or instructions included in a program. In one example, the processor 140 may be implemented in the form of a microprocessor, a central processing unit (CPU), a processor core, a multiprocessor, an application-specific integrated circuit (ASIC), or a field programmable gate array (FPGA), but the scope of an embodiment of the present disclosure is not limited thereto.

The processor 140 is configured to execute the offline NFT photo card transaction management program or instructions and perform the following functions and procedures.

The processor 140 may perform functions related to generating, deleting, and managing NFT photo cards.

The processor 140 may set the offline NFT photo card transaction area 1000 based on the installation information of the location information device 300. In addition, the processor 140 may register an NFT photo card that a user holding an NFT photo card wishes to sell, purchase, or exchange as an NFT photo card to be traded.

In addition, the processor 140 may match an NFT photo card transaction counterparty for the user terminal 200 located in the offline NFT photo card transaction area 1000. When the NFT photo card transaction counterparty is matched, the processor 140 may set a transaction place based on the location information of the user terminal and the counterparty terminal. In this regard, the transaction place may be set as a midpoint or another location at which travel distances of the parties are equal, and the transaction place may be defined as an area within a radius of 1 to 2 meters (m) from that location.

In addition, the transaction location may be set automatically or by defining the transaction place as an area within a radius of 1 to 2 meters (m) centered on a location selected by one or more parties.

In addition, the processor 140 may perform an NFT photo card transaction when the terminals of all parties have entered the transaction place and may store NFT photo card transaction data in the database 130 using blockchain technology.

In addition, the processor 140 sets an offline NFT photo card transaction area based on one or more beacon transmitters installed together with a communication device installed in a pop-up store, concert hall, fan signing venue, or fan meeting venue.

In addition, the processor 140 may classify a registered NFT photo card to be traded as one or more of an NFT photo card to be sold, an NFT photo card to be purchased, or an NFT photo card to be exchanged. In addition, the processor 140 may generate an NFT photo card transaction list for at least one of the NFT photo cards to be sold, the NFT photo cards to be purchased, or the NFT photo cards to be exchanged.

In addition, the processor 140 generates the NFT photo card transaction list based on the distance between the user terminal and an NFT photo card transaction counterparty terminal.

In addition, the processor 140 may display an NFT photo card registered by a user who has used a display-priority item at the top of the NFT photo card transaction list.

In addition, the processor 140 may match a transaction counterparty based on at least one of information regarding an NFT photo card to be purchased, information regarding the NFT photo card to be sold, or information regarding the NFT photo card to be exchanged, and based on distance information associated with a transaction counterparty terminal.

In addition, the processor 140 may stop providing a transaction function for a user account that registers more than a preset number of identical NFT photo cards.

In addition, the processor 140 determines whether a seller terminal, a buyer terminal, or an exchange terminal has entered the transaction place based on at least one piece of the location information of the seller terminal, the buyer terminal, and the exchange terminal.

In addition, when the seller terminal and either the buyer terminal or the exchange terminal enter the transaction place, the processor 140 may request authentication for the NFT photo card transaction or exchange. Upon receiving the authentication request, the user terminal 200 may perform authentication using a predefined password input method or a biometric authentication method, and when authentication is completed, data processing for the NFT photo card transaction or exchange may be performed.

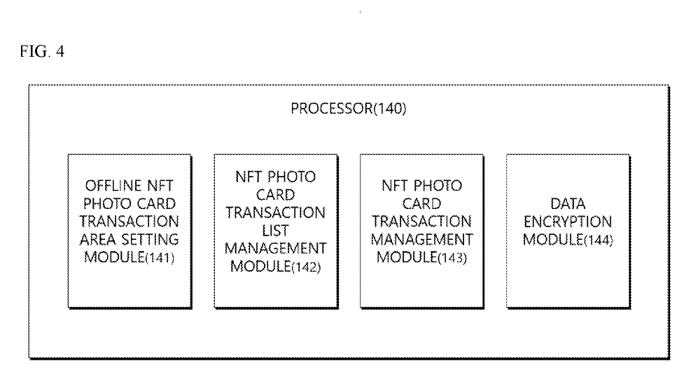

Hereinafter, the functions of the offline NFT photo card transaction management server are described in detail with reference to FIG. 4.

FIG. 4 is a conceptual diagram illustrating the functions of an offline NFT photo card transaction management server according to an embodiment of the present disclosure.

Referring to FIG. 4, the offline NFT photo card transaction management server 100 may perform the functions of an offline NFT photo card transaction area setting module 141, an NFT photo card transaction list management module 142, an NFT photo card transaction management module 143, and a data encryption module 144.

The offline NFT photo card transaction area setting module 141 sets the range of the offline NFT photo card transaction area in which offline transactions of NFT photo cards may be performed. The offline NFT photo card transaction area setting module 141 may be set based on the installation information of one or more location information devices 300.

In addition, the offline NFT photo card transaction area setting module 141 may provide an offline NFT photo card transaction function to the terminal 200 of a user who has entered the offline NFT photo card transaction area 1000.

Users who have entered or are planning to enter the offline NFT photo card transaction area 1000 may register the NFT photo cards in their possession as NFT photo cards to be sold. In addition, users may register NFT photo cards in their possession or photo cards that the users wish to purchase as NFT photo cards.

In addition, when a user wishes to exchange an NFT photo card, the user may register, as an NFT photo card to be exchanged, an NFT photo card in the user's possession that the user wishes to exchange for another NFT photo card.

The information on an NFT photo card to be sold, to be purchased, or to be exchanged that is registered by users is stored in the NFT photo card transaction list management module 142 and/or the database 130.

The NFT photo card transaction list management module 142 may generate a list of at least one of the NFT photo cards to be sold, the NFT photo cards to be purchased, or the NFT photo cards to be exchanged that are registered by a user located within the offline NFT photo card transaction area 1000. In addition, the NFT photo card transaction list management module 142 may provide the generated NFT photo card transaction list to a user or the user terminal 200 located within the offline NFT photo card transaction area 1000.

The NFT photo card transaction list management module 142 may generate an NFT photo card transaction list based on the registration time of the NFT photo card or on the price of the NFT photo card.

In addition, based on location information of the terminal 200 within the offline NFT photo card transaction area 1000, the NFT photo card transaction list management module 142 may generate the NFT photo card transaction list so that NFT photo cards registered for trading by users whose terminals are closer to the terminal 200 are displayed earlier in the list.

In addition, the NFT photo card transaction list management module 142 may prioritize display of an NFT photo card registered by a user who has used an item by displaying the NFT photo card at the top of the NFT photo card transaction list or at a location having a higher exposure frequency. In this regard, such items may be purchased or redeemed using digital goods that may be acquired through paid transactions or by satisfying predetermined conditions.

In addition, the NFT photo card transaction list management module 142 may suspend a transaction function for a user account that registers more than a predefined number of identical NFT photo cards. Users who register multiple identical NFT photo cards may be treated as merchants rather than fans. In order to foster a healthy fan culture and photo card transaction culture, transaction functions may be withheld from users deemed to be merchants.

In addition, a transaction counterparty may be identified by selecting a transaction target from the NFT photo card transaction list or by automatically matching a transaction counterparty, and counterparty matching and NFT photo card transaction processing may be performed using the NFT photo card transaction management module 143.

When the method of automatically matching the transaction counterparty is selected, the transaction counterparty may be matched based on information on at least one of the NFT photo cards to be sold, NFT photo card to be purchased, or NFT photo card to be exchanged that is registered by a user, the location information of the user terminal, information on at least one of the NFT photo card to be sold, the NFT photo card to be purchased, or the NFT photo card to be exchanged that is registered by the transaction counterparty, and the location information of a transaction counterparty terminal.

Specifically, based on information identifying an NFT photo card that a user wishes to sell, the automatic matching method may select, as the transaction target, the counterparty terminal located closest to the user terminal among counterparties registered in association with the same NFT photo card.

In addition, based on information identifying an NFT photo card held by the user and an NFT photo card that the user wishes to acquire through exchange, the automatic matching method may select, as the transaction target, the counterparty terminal located closest to the user terminal among counterparties registered in association with mutually corresponding NFT photo cards.

In this regard, the automatic matching method may use not only distance-based matching, but also matching based on the number of transactions, the number of NFT photo cards in possession, transaction history, and fraud history.

In addition, the NFT photo card transaction management module 143 may reserve items listed for transaction from the NFT photo card transaction list. When a user in possession of a reserved item enters the offline NFT photo card transaction area 1000, the user may be matched as a transaction counterparty.

When the transaction counterparty is matched, the NFT photo card transaction management module 143 may set a transaction place at which a user wishing to perform an NFT photo card transaction and the transaction counterparty meet offline. In this regard, the transaction place may be set by allowing the user or the transaction counterparty to select a specific location or coordinates in a map interface corresponding to the offline NFT photo card transaction area 1000.

In addition, when the transaction counterparty is matched, the NFT photo card transaction management module 143 may automatically set the transaction place. In this regard, the NFT photo card transaction management module 143 may set the transaction place as a midpoint or another point at which travel distances are equal based on the locations of the user terminal and the transaction counterparty terminal.

In addition, the NFT photo card transaction management module 143 may define the transaction place as having a predetermined range. Accordingly, the NFT photo card transaction management module 143 may define the transaction place as an area having a radius of 1 to 3 meters (m) centered on a specific location or coordinates selected by the user or the transaction counterparty, or as an area having a radius of 1 to 3 meters (m) centered on a midpoint or another point at which travel distances are equal based on the locations of the user terminal and the transaction counterparty terminal.

The radius of 1 to 3 meters (m) described above is merely an example for explaining an embodiment of the present disclosure, and the radius of the transaction place may be defined in various ways depending on the settings of a user or administrator.

After the transaction place is set, the NFT photo card transaction management module 143 determines whether the user terminal and the transaction counterparty terminal have entered the transaction place. When the user terminal and the counterparty terminal enter the transaction place, a transaction or exchange of the NFT photo card may be performed.

In this regard, the NFT photo card transaction management module 143 may request authentication, such as a predefined password input method, biometric authentication method, or pattern input method, from the transaction counterparty terminal and the user terminal entering the transaction place to perform the transaction or exchange of the NFT photo card. The NFT photo card transaction management module 143 may perform data processing for the NFT photo card transaction or exchange when authentication is completed.

The data encryption module 144 encrypts NFT photo card transactions and exchange data, and stores the NFT photo card transactions and exchange data in the database 130 using blockchain.

Specifically, the data encryption module 144 records transaction data as a data block, and the data block includes information related to the NFT photo card transaction, such as user information participating in the transaction, transaction NFT photo card information, transaction time information, transaction location information, and transaction authentication information.

In addition, the data block is divided into a body and a header. The body stores transaction details, and the header stores cryptographic codes such as Merkle hash (Merkle root) or nonce.

The data blocks generated in the data encryption module 144 are interconnected to form a blockchain, and a cryptographic hash links the data blocks in the chain. When the contents of a data block are modified intentionally or unintentionally, the hash value changes, thereby enabling the detection of data tampering. In addition, in order to modify transaction data stored in a data block, corresponding modification or verification of a previous data block and the overall chain may be required.

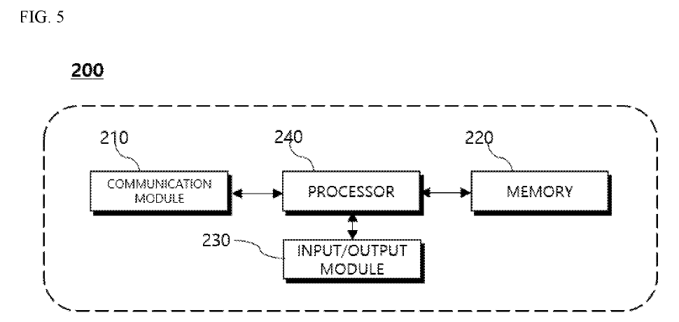

FIG. 5 is a block diagram illustrating the configuration of the terminal 200.

Referring to FIG. 5, the terminal 200 includes a memory 220, an input/output module 230, and a processor 240, and may further include a communication module 210.

The communication module 210 may transmit and receive information to and from an external database or an external device. In one example, the external device may be the offline NFT photo card transaction management server (100 in FIG. 2) described above. The memory 220 may store an offline NFT photo card transaction management program or application. The term 'offline NFT photo card transaction management program or application' is used for convenience of explanation and does not limit the functionality of the program or application.

The input/output module 230 may receive information or data transmitted from an external source to the terminal 200 or output information or data stored by the terminal 200 to an external destination. For example, the input/output module 230 may include a display or a touchpad. The processor 240 executes the offline NFT photo card transaction management program or application stored in the memory 220. Further description of the communication module 210, the memory 220, and the processor 240 is omitted because those elements may correspond, respectively, to the communication module 110, the memory 120, and the processor 140 described above with reference to FIG. 3.

The processor 240 is configured to execute the offline NFT photo card transaction management program or application to perform the following functions and procedures.

The processor 240 may display data received from the offline NFT photo card transaction management server 100 or generate and display an interface based on information received from the offline NFT photo card transaction management server 100.

In addition, the processor 240 may display information on the NFT photo card held by the user account, may set an NFT photo card to be sold or an NFT photo card to be exchanged based on the displayed information, and may transmit information regarding the set NFT photo card to be sold or exchanged to the offline NFT photo card transaction management server 100.

In addition, the processor 240 may set an NFT photo card that a user wishes to purchase or an NFT photo card that the user wishes to acquire through exchange, and may transmit information regarding the set NFT photo card to be purchased or exchanged to the offline NFT photo card transaction management server 100.

In addition, the processor 240 may display an NFT photo card transaction list received from the offline NFT photo card transaction management server 100 or transmit information on a transaction counterparty selected from the NFT photo card transaction list to the offline NFT photo card transaction management server 100.

In addition, the processor 240 may display a map interface corresponding to the offline NFT photo card transaction area 1000 or transmit transaction place setting information selected by a user to the offline NFT photo card transaction management server 100.

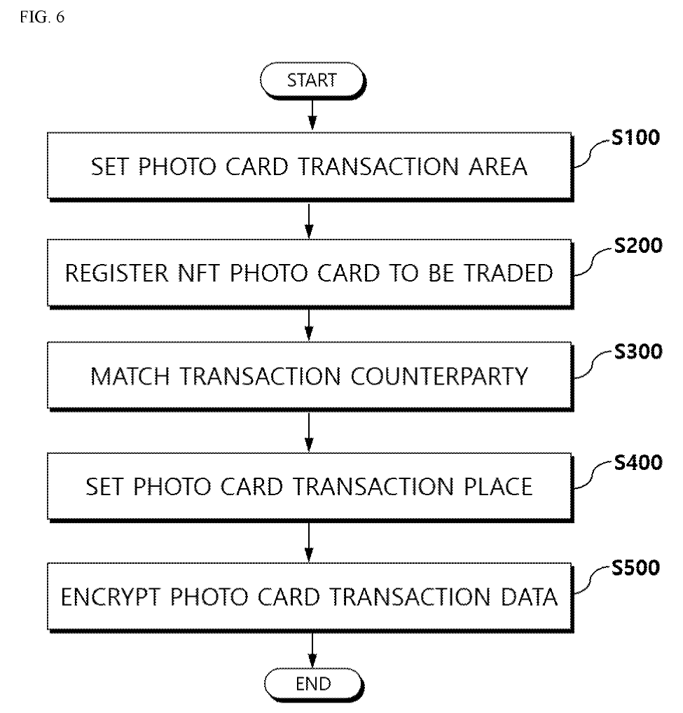

FIG. 6 is a flowchart of an offline NFT photo card transaction method according to an embodiment of the present disclosure.

Referring to FIG. 6, the offline NFT photo card transaction method includes: setting an offline NFT photo card transaction area (S100); registering an NFT photo card to be traded (S200); matching a transaction counterparty (S300); setting a transaction place (S400); and encrypting photo card transaction data (S500).

In the setting of the photo card transaction area (S100), the offline NFT photo card transaction management server 100 sets the range of the offline NFT photo card transaction area 1000 in which offline transactions of NFT photo cards may be performed. In this connection, the offline NFT photo card transaction area 1000 may be set centered on a base area where fans of a specific artist are concentrated, such as a pop-up store, a concert hall, a fan meeting venue, or a fan signing venue.

In addition, the setting of the photo card transaction area (S100) may include setting the offline NFT photo card transaction area based on one or more beacon broadcasters installed together with a communication device installed in a pop-up store, a concert hall, a fan signing venue, or a fan meeting venue.

The offline NFT photo card transaction area 1000 may be set based on the installation information of the location information device 300 installed in a base area, and at least one location information device 300 may be installed together with a communication device installed in the base area.

In addition, the offline NFT photo card transaction management server 100 may acquire location information of the terminal 200 located within the offline NFT photo card transaction area 1000 using the location information device 300.

When the offline NFT photo card transaction area 1000 is set, users who hold NFT photo cards may search for transaction counterparties or conduct NFT photo card transactions within the offline NFT photo card transaction area 1000.

In the registration of the NFT photo card to be traded (S200), a user who holds or wishes to exchange an NFT photo card or a user who wishes to purchase an NFT photo card may register the NFT photo card the user wishes to trade.

In the registration of the NFT photo card to be traded (S200), the information on the NFT photo card to be sold, the NFT photo card to be purchased, and the NFT photo card to be exchanged that is registered by users is stored in the offline NFT photo card transaction management server 100.

In the registration of the NFT photo card to be traded (S200), the method may include suspending the transaction function for a user account that registers more than a predefined number of identical NFT photo cards.

In addition, the offline NFT photo card transaction management server 100 may generate an NFT photo card transaction list for at least one of the NFT photo cards to be sold, the NFT photo cards to be purchased, or the NFT photo cards to be exchanged based on the information registered by users and location information of the user terminal and may provide the list to the terminal 200.

The generation of the NFT photo card transaction list may display, at the top of the NFT photo card transaction list, an entry associated with a transaction counterparty located close to the user terminal, or may generate the NFT photo card transaction list based on the proximity of the transaction counterparty to the user terminal.

In addition, the generation of the NFT photo card transaction list may include displaying, at the top of the NFT photo card transaction list, an NFT photo card registered by a user who has used a display-priority item. In this connection, the item refers to an item that displays the NFT photo card registered as a transaction target at the top of the NFT photo card transaction list or in a location with high exposure frequency. In addition, the item may be purchased or replaced using digital goods that may be acquired through paid payments or by achieving certain conditions.

In the matching of the transaction counterparty (S300), the NFT photo card transaction counterparty may be searched using a method of selecting a transaction target from the NFT photo card transaction list or a method of automatically matching a transaction counterparty.

When the method of automatically matching the transaction counterparty is selected, the matching of the transaction counterparty (S300) may include matching a transaction counterparty based on at least one piece of information on the NFT photo card to be purchased, the NFT photo card to be sold, and the NFT photo card to be exchanged, and distance information from the transaction counterparty terminal.

In the matching of the transaction counterparty (S300), the offline NFT photo card transaction management server 100 may match the transaction counterparty based on information on at least one of the NFT photo card to be sold, the NFT photo card to be purchased, or the NFT photo card to be exchanged that is registered by a user, the location information of the user terminal, information on at least one of the NFT photo card to be sold, the NFT photo card to be purchased, or the NFT photo card to be exchanged that is registered by the transaction counterparty, and the location information of a transaction counterparty terminal.

Specifically, the method of automatically matching the transaction counterparty may be configured to match, as a transaction target, the transaction counterparty terminal located closest to the user terminal among the transaction counterparties who have registered the identical NFT photo card as the NFT photo card to be sold based on the information of the NFT photo card to be sold that a user wishes to sell.

In addition, the method of automatically matching the transaction counterparty may be configured to match, as a transaction target, the transaction counterparty terminal located closest to the user terminal among the transaction counterparties who have registered the mutually matching NFT photo cards as the NFT photo cards to be exchanged based on the information on the NFT photo card to be exchanged among the NFT photo cards that a user holds and the information on the NFT photo card that the user wishes to exchange (acquire).

In this connection, the method of automatically matching the transaction counterparty may apply not only a matching method based on distance, but also a matching method based on the number of transactions, the number of NFT photo cards in possession, transaction history, and fraud history.

In addition, the NFT photo card transaction management module 143 may reserve items for a transaction from the NFT photo card transaction list. When a user in possession of a reserved item enters the offline NFT photo card transaction area 1000, the user may perform matching as a transaction counterparty.

In the setting of the photo card transaction place (S400), the offline NFT photo card transaction management server 100 sets a transaction place for a user wishing to perform an NFT photo card transaction and the transaction counterparty to meet offline. In this connection, the transaction place may be set using a method in which the user or the transaction counterparty selects a specific location or coordinates in the Maps interface corresponding to the offline NFT photo card transaction area 1000.

In addition, in the setting of the photo card transaction place (S400), when the transaction counterparty is matched, the offline NFT photo card transaction management server 100 may automatically set a transaction place. In this connection, the offline NFT photo card transaction management server 100 may set a midpoint or a point with the same movement distance as the transaction place based on the locations of the user terminal and the transaction counterparty terminal.

In addition, the offline NFT photo card transaction management server 100 may set the transaction place to have a certain range. Accordingly, the offline NFT photo card transaction management server 100 may set a 1 to 3 meter (m) radius as the transaction place centered on a specific location or coordinates selected by the user or the transaction counterparty, or may set a 1 to 3 meter (m) radius as the transaction place centered on a midpoint or a point with the same movement distance based on the locations of the user terminal and the transaction counterparty terminal.

The radius of 1 to 3 meters (m) described above is merely an example for explaining an embodiment of the present disclosure, and the radius of the transaction place may be set in various ways depending on the settings of a user or administrator.

After the transaction place is set, the offline NFT photo card transaction management server 100 determines whether the user terminal and the transaction counterparty terminal have entered the transaction place. When the user terminal and the counterparty terminal enter the transaction place, the NFT photo card transaction management module 143 may perform a transaction or exchange of the NFT photo card.

In this connection, the offline NFT photo card transaction management server 100 may request authentication, such as a preset password input method, biometric authentication method, or pattern input method, from the transaction counterparty terminal and the user terminal entering the transaction place to perform the transaction or exchange of the NFT photo card. The NFT photo card transaction management module 143 may perform data processing for the NFT photo card transaction or exchange when authentication is completed.

In the encryption of the photo card transaction data (S500), the offline NFT photo card transaction management server 100 encrypts the NFT photo card transaction and exchange data, and stores the NFT photo card transaction and exchange data in the database 130 using blockchain.

Specifically, the data encryption module 144 records transaction data as a data block, and the data block includes information related to the NFT photo card transaction, such as user information participating in the transaction, transaction NFT photo card information, transaction time information, transaction location information, and transaction authentication information.

In addition, the data block is divided into a body and a header. The body stores transaction details, and the header stores cryptographic codes such as Merkle hash (Merkle root) or nonce.

The data blocks generated in the data encryption module 144 are interconnected to form a blockchain, and an encryption hash is added along with the NFT photo card transaction to serve as a chain. When the contents of a data block are modified intentionally or unintentionally, the hash value changes to detect data tampering. In addition, in order to modify transaction data stored in a data block, modification or verification of the previous data block and the entire data block needs to be performed.

The above description is merely illustrative of the present disclosure, and one of ordinary skill in the art will appreciate that the present disclosure may be embodied in other specific forms without departing from the technical spirit or essential features of the present disclosure. Therefore, the embodiments described above are illustrative in all aspects and should not be understood as limiting. For example, each element described as having an integrated form may be embodied in a distributed manner, and likewise, elements that are described as being distributed may be embodied in an integrated form.

The scope of the present disclosure is defined by the appended claims, and all modifications or equivalents falling within the meaning and scope of the claims are intended to be included within the scope of the present disclosure.

### Mode for Carrying Out the Invention

The mode for carrying out the invention is the same as the best mode for carrying out the invention described above.

### Industrial Applicability

An embodiment of the present disclosure relates to an offline NFT photo card transaction method and apparatus and is applicable to NFT-related and entertainment-related industries, and thus has industrial applicability.

1. An offline NFT photo card transaction method, the method comprising:
setting an offline NFT photo card transaction area;
registering an NFT photo card to be traded by an NFT photo card holder;
matching an NFT photo card transaction counterparty for a user terminal located in the offline NFT photo card transaction area;
setting a transaction place based on location information of the user terminal and a counterparty terminal when the NFT photo card transaction counterparty is matched; and
performing an NFT photo card transaction when the user terminal and the counterparty terminal enter the transaction place.

2. The method of claim 1 wherein the setting of the offline NFT photo card transaction area comprises setting the offline NFT photo card transaction area based on one or more beacon transmitters installed together with a communication device installed in a pop-up store, concert hall, fan signing venue, or fan meeting venue.

3. The method of claim 2, wherein the registration of the NFT photo card to be traded comprises:setting at least one of an NFT photo card to be sold, an NFT photo card to be purchased, or an NFT photo card to be exchanged; andgenerating an NFT photo card transaction list for at least one of the NFT photo card to be sold, the NFT photo card to be purchased, or the NFT photo card to be exchanged.

4. The method of claim 3, wherein the generation of the NFT photo card transaction list comprises generating the NFT photo card transaction list based on a distance between the user terminal and an NFT photo card transaction counterparty terminal.

5. The method of claim 4, wherein the generation of the NFT photo card transaction list further comprises displaying, at the top of the NFT photo card transaction list, an NFT photo card registered by a user who has used a display-priority item.

6. The method of claim 5, wherein the matching of the NFT photo card transaction counterparty comprises matching a transaction counterparty based on at least one of information regarding the NFT photo card to be purchased, information regarding an NFT photo card to be sold, or information regarding an NFT photo card to be exchanged, and based on distance information associated with a transaction counterparty terminal.

7. The method of claim 6, wherein the registration of the NFT photo card to be traded comprises suspending a transaction function for a user account that registers more than a predefined number of identical NFT photo cards.

8. The method of claim 7, wherein performing the NFT photo card transaction comprises:determining whether a seller terminal, a buyer terminal, or an exchange terminal has entered the transaction place based on location information associated with at least one of the seller terminal, the buyer terminal, and the exchange terminal;requesting authentication for an NFT photo card transaction or exchange when the seller terminal and either the buyer terminal or the exchange terminal enter the transaction place;performing the authentication using a predefined password input method or a biometric authentication method; andperforming data processing for the NFT photo card transaction or exchange when the authentication is completed.

9. An offline NFT photo card transaction apparatus, the apparatus comprising:a communication module configured to transmit and receive information between a terminal and an offline NFT photo card transaction management server;a memory for storing at least one instruction; anda processor for executing the at least one instruction,wherein the processor is configured to:set an offline NFT photo card transaction area;register an NFT photo card to be traded by an NFT photo card holder;match an NFT photo card transaction counterparty for a user terminal located in the offline NFT photo card transaction area;set a transaction place based on location information of the user terminal and a counterparty terminal when the NFT photo card transaction counterparty is matched; andperform the NFT photo card transaction when the user terminal and the counterparty terminal enter the transaction place.

10. The apparatus of claim 9, wherein the processor is configured to set the offline NFT photo card transaction area based on one or more beacon transmitters installed together with a communication device installed in a pop-up store, concert hall, fan signing venue, or fan meeting venue.

11. The apparatus of claim 10, wherein the processor is configured to generate an NFT photo card transaction list for at least one of an NFT photo card to be sold, an NFT photo card to be purchased, or an NFT photo card to be exchanged.

12. The apparatus of claim 11, wherein the processor is configured to display, at the top of the NFT photo card transaction list, an entry associated with a transaction counterparty located close to the user terminal.

13. The apparatus of claim 12, wherein the processor is configured to display, at the top of the NFT photo card transaction list, an NFT photo card registered by a user who has used a display-priority item.

14. The apparatus of claim 13, wherein the processor is configured to match a transaction counterparty based on at least one of information regarding an NFT photo card to be purchased, information regarding an NFT photo card to be sold, or information regarding an NFT photo card to be exchanged, and based on distance information associated with a transaction counterparty terminal.

15. The apparatus of claim 14, wherein the processor is configured to suspend a transaction function for a user account that registers more than a predefined number of identical NFT photo cards.

16. The apparatus of claim 15, wherein the processor is configured to:determine whether a seller terminal, a buyer terminal, or an exchange terminal has entered the transaction place based on at least one of location information associated with the seller terminal, the buyer terminal, and the exchange terminal;request authentication for NFT photo card transaction or exchange when the seller terminal and either the buyer terminal or the exchange terminal enter the transaction place;perform authentication using a predefined password input method or a biometric authentication method; and perform data processing for the NFT photo card transaction or exchange when the authentication is completed.
